(19) United States
(12) Patent Application Publication
(10) Pub. No.: US 2015/0347964 A1
(43) Pub. Date: Dec. 3, 2015

(54) METHOD AND SYSTEM FOR DISTRIBUTING DELIVERY OF ITEMS

(71) Applicant: HTI, IP, L.L.C., Arlington, VA (US)

(72) Inventor: Thomas Steven Taylor, Atlanta, GA (US)

(73) Assignee: HTI, IP, L.L.C., Arlington, VA (US)

(21) Appl. No.: 14/294,695

(22) Filed: Jun. 3, 2014

(51) Int. Cl. G06Q 10/08; G06Q 30/08

(52) U.S. Cl. CPC G06Q 10/08355; G06Q 30/08; G06Q 10/0833

(57) ABSTRACT

A system comprises a computing device configured to execute a software application on a processor of the computing device to provide operations that compute a primary delivery route based on a plurality of primary delivery addresses. The system receives at least one priority delivery request associated with a transient individual location. The transient individual location is compared with the primary delivery route. A detour route is generated from the primary delivery route when the transient individual location is proximate to the primary delivery route.

### BACKGROUND

Delivery methodologies utilize routes based on a series of fixed delivery addresses. The use of fixed delivery addresses may not always be conducive to modern society's mobile lifestyles. Recipients may move between multiple locations during a given day. When priority deliveries require delivery on a certain date or even by a certain time on a given date, challenges arise when the recipient cannot remain at a single delivery address for the entire potential delivery period. As such, it would be highly beneficial for a delivery methodology that could efficiently address priority deliveries with transient delivery locations. It would be beneficial to distribute such priority delivery such that the primary fixed address delivery is minimally impacted

### BRIEF DESCRIPTION OF THE DRAWINGS

FIG. 1 illustrates an exemplary system for distributed delivery of packages including priority deliveries directed to transient individual locations.

FIG. 2 illustrates an exemplary process flow for delivery of packages along a delivery route including priority packages to transient individual locations.

FIG. 3 illustrates an exemplary process flow for distributed delivery of packages utilizing secondary delivery vehicles.

### DETAILED DESCRIPTION

A method and system for distributed delivery is provided utilizing an efficient methodology for accommodating priority deliveries where the priority delivery may not be sent to a static address. The system may utilize a combination of a primary delivery route as well as the flexibility of generating a detour to deliver a priority delivery to a transient individual location. The system may monitor the delivery vehicle location and generate the detour when that location is proximate to the transient individual location. This minimizes the impact of the priority delivery on the original primary delivery route.

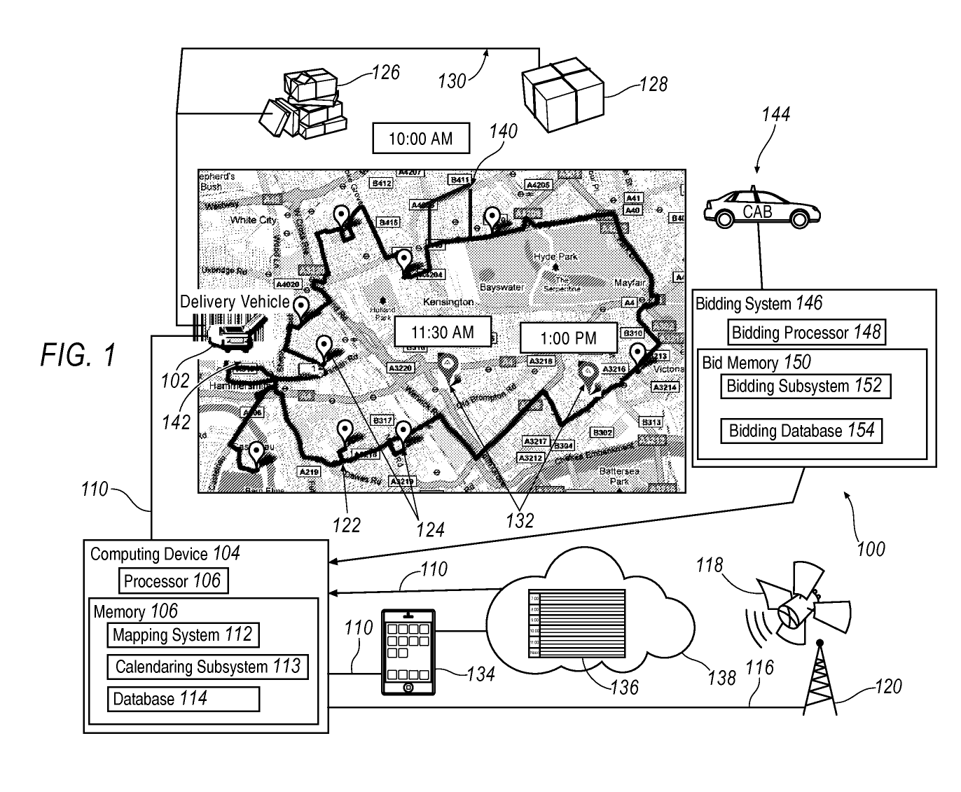

FIG. 1 illustrates an exemplary delivery system 100 having a delivery vehicle 102 in communication with a computing device 104. The computing device 104 may include a processor 106, a memory 108, and use communication channels 110. The memory 108 may hold a mapping subsystem 112, a calendaring subsystem 113, and a database 114. The communication channels 110 may include a network 116. Network 116 may include one or more networks of various types. For example, network 116 may include a cable network (e.g., an optical cable network), a wireless satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet. The network 116 may be in communication with a Global Positioning System (GPS) 118 and/or a plurality of communication towers 120. System 100 may take many different forms and include multiple and/or alternate components and facilities. While an exemplary system 100 is shown in FIG. 1, the exemplary components illustrated in Figure are not intended to be limiting. Indeed, additional or alternative components and/or implementations may be used.

As illustrated in FIG. 1, in an exemplary approach system 100 includes a computing device 104 configured to compute a primary delivery route 122 based on a plurality of primary delivery addresses 124 for a plurality of delivery packages 126. The primary delivery route 122 may be any driving or navigating route that allows for packages or other items to be delivered to the delivery addresses 122 in an efficient manner. The system 100 further may include at least one priority package 128 requiring a priority delivery request 130. The priority delivery request is associated with a transient individual location 132 which may be the variable position of an individual during the delivery period. This transient individual location 132 may be determined through the use of a mobile device 134 in communication with the GPS 118 and/or the plurality of network towers 120. This may be done using the GPS 118. It may also be done using multilateration of radio signals wherein the location of a nearby antenna tower 120 to the mobile device 134 is used to locate the device, i.e. triangulation. Additionally, software within the mobile device 134 may be used to identify the location of the device 134. In this example, the service provider may continuously receive location information from the mobile device 134. In another example, signal strength and mobile device identification may be used to track the location of the mobile device 134. In still another exemplary illustration, the transient individual location 132 may be a series of logged geographic locations stored within a location schedule 136, such as a personal or group calendar, or stored within a cloud storage 138 on the Internet. Cloud storage 138 includes networked on-line storage where multiple virtual servers may be used to store data. The location schedule 136 may be synced with the calendaring subsystem 113 to coordinate transient individual location 132 with the computing device 104.

The system 100 computes the primary delivery route 122 based on the plurality of primary delivery addresses 124 in fashion to guide the delivery vehicle 102 around the delivery local in an efficient manner. The priority delivery request 130, however, is associated with a transient individual location 132 that changes throughout the day. The system 100 can deliver to the individual's location rather than a fixed address such as a home or office to insure delivery is achieved to the specific individual. As is illustrated in FIG. 1, the transient individual location 132 can represent multiple locations at different times during the delivery period. These locations and times may be monitored or determined in a variety of fashions.

In one illustrative example, the transient individual location 116 may be obtained by monitoring a mobile device 134 associated with the individual requesting delivery. The mobile device 134 may include any electronic device, including but not limited to a cellular phone, smart phone, tablet computer, laptop computer, e-reader, personal computer, MP3 device, etc. The mobile device 134 may be capable of facilitating communications such as voice calls, text messaging, Internet access, etc. The mobile device 134 allows accurate geo-location of the individual. In another exemplary example, the transient individual location 132 may be monitored through the use of pre-stored geo-locations on the cloud storage 138 maintained online. In this example, the customer can fill out an online location schedule 136 that describe his or her locations during various times of the day. In still another example, the individual's mobile device 134, which commonly stores personal calendars 136, may upload such a personal calendar 136 to the cloud 138 either by syncing or through the use of a specialized application. In yet a further example, the individual may manually input a current location or an upcoming location in a manner that can be communicated to computing device 104. The computing device 104, therefore, has the ability to determine the transient individual location 132 as it changes during the day.

The system 100 compares the transient individual location 132 with the primary delivery route 122 to generate a detour route 140 to engage one of the transient individual locations 132. This may be when the transient individual location 132 is proximate to the primary delivery route 122 to minimize driving distance, driving time, or transit method. It may also be when the transient individual location 132 is proximate to both the primary delivery route 122 and the delivery vehicle location 142. The system monitors both the delivery vehicle location 142 in real or at least near real-time as well as the changing transient individual location 132 to coordinate when the delivery truck 102 along its route is closest to the intended recipient. This may include one or more factors such as closest in distance, closest in time, or even least disruptive to the primary delivery route 122. The term proximate is intended to encompass any geographic factor, time factor, or convenience factor related to the primary delivery route 122. The system 100 may further call or message the individual, such as by mobile device 134, prior to generating the detour route 122 to confirm the transient individual location 132. This allows an individual stuck in a meeting or whose pre-loaded schedule has altered unexpectedly to confirm delivery prior to diverting the delivery truck 102.

In one example, when the transient individual location 132 is comprised of a plurality of fixed locations over time, such as those obtained from the online location schedule 136, a number of locations along the primary delivery route 122 may be identified corresponding to these fixed locations. In this example, a number of potential detour routes 140 may be determined utilizing each of the fixed locations compared to the primary delivery route 122. These potential detour routes 140 may be provided to the delivery vehicle 102 as well as the intended recipient via the individuals mobile device 134. The delivery vehicle 102 may then contact the mobile device 134 to inform the individual of a selected detour route 140. Alternatively, the individual may be contacted via the mobile device 134 and select a preferred detour route 140 to one of the selected fixed locations from the online location schedule 136.

There may be times when even the most efficiently calculated detour route 140 may significantly impact the delivery truck 102. These situations may arise when the transient individual location 132 is in a city center with limited access, is in a high rise building, or even when the primary delivery route 106 is too time sensitive to allow for a detour. The system 100 may in these examples contact a secondary delivery vehicle 144 to intercept the delivery truck 102 and implement the detour route 140. In one exemplary example, the secondary delivery vehicle may include a smaller delivery vehicle, a third party delivery vehicle, a cab, a courier, or even a freelance delivery vehicle. These secondary delivery vehicles 144 may be simply re-tasked from their existing operations. The secondary delivery vehicle 144 may be scheduled to meet the primary delivery truck 102 at a secure location such as any of the primary delivery addresses 124 at which the priority package 128 may be transferred between the vehicles. When secondary delivery vehicles 144 are monitored by a dispatch or similar known system, they can be contacted directly by a dispatch agent to identify the closest vehicle to the primary delivery truck. In another exemplary illustration, the primary delivery truck 102 may drop off the priority package 128 at a secured location near the primary delivery route 122 such as a locker, a local shipping office, or even a manned lobby. The secondary delivery vehicle 144 may then accept transfer of the priority package 128 independent of the primary delivery truck 102 location.

In one exemplary illustration, the secondary delivery vehicle 144 is obtained by a bidding system 146 in communication with the computing device 104. The bidding system 146 may include a bid processor 148, a bid memory 150, and use the communication channels 110. The memory 148 may hold a bidding subsystem 152, and bidding database 154. The bidding system 146 soliciting bids from secondary delivery vehicles 144 already heading towards or near the transient individual location 132 to facilitate the detour route 140 in a cost and time efficient manner. In one exemplary example, the bidding system 146 may comprise an independent system from the computing device 104. In another exemplary example, the bidding system 146 may comprise a subsystem of the computing device 104.

In an example wherein the transient individual location 132 is determined utilizing the online location schedule 136 including a plurality of fixed locations over time, the primary delivery truck 102 may utilize the plurality of potential detour routes 140 to select the secondary delivery vehicle 144. The potential detour routes 140 may be utilized to determine pricing for the secondary delivery or may be utilized to determine which secondary delivery vehicles 144 will be in the correct location for each of the potential detour routes 140. This aids in the selection of the most efficient or cost effective secondary delivery vehicle 144. When the selection of the secondary delivery vehicle 144 utilizes the bidding system 152, the potential detour routes 140 may be utilized by parties involved in the bidding system 152 in formulating appropriate bids or the selection of appropriated submitted bids.

In general, computing systems and/or devices, such as the computing device 104 mobile device 134, the devices making up cloud storage 138 and bidding system 146, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices such as the computing device 104 include computer-executable instructions such as the instructions of the software applications on a processor, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

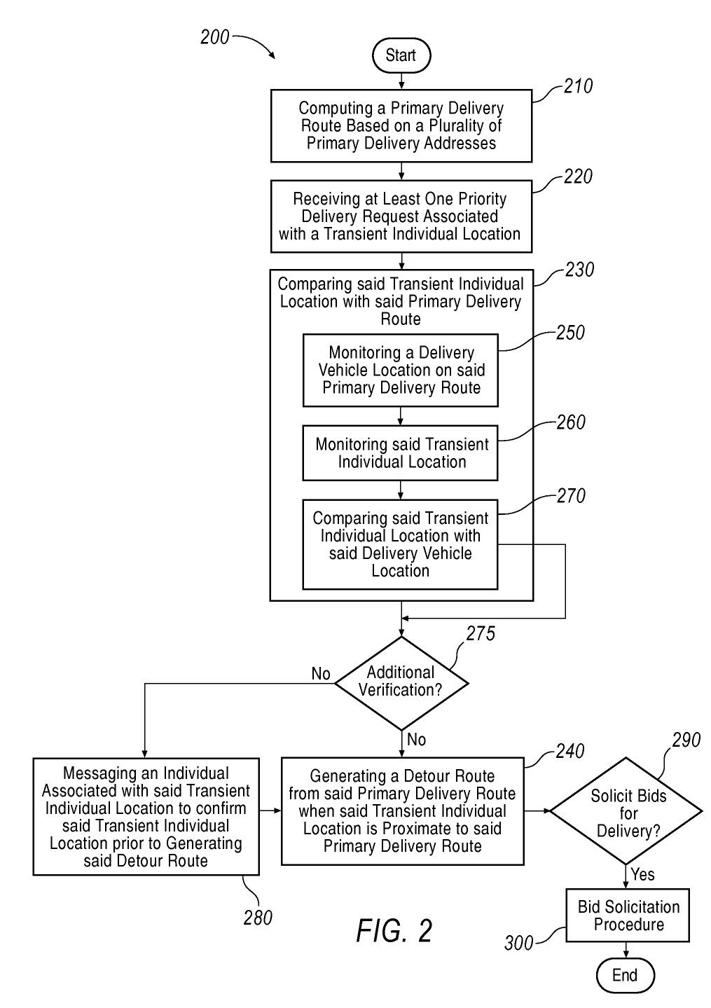

FIG. 2 illustrates an exemplary process flow 200 for distributed delivery of packages. In block 210 a primary delivery route is computed based on a plurality of delivery addresses. In block 220 at least one priority delivery requests is received that is associated with a transient individual location. In one exemplary example, the at least one priority delivery request may include a plurality of priority delivery requests. In block 230, the transient individual location is compared to the primary delivery route. In block 240 a detour route is generated from the primary delivery route when the transient individual location is proximate to the primary delivery route. In one exemplary non-limiting example, this is a distance of less than five (5) miles. In another exemplary example, this is an additional delivery time of less than twenty (20) minutes. In another example, it may represent any distance or time that does not unacceptably impact the primary delivery route. When the number of priority delivery requests rises to a level wherein the primary delivery route would be significantly impacted, the exemplary process flow 300 below may be utilized to solicit secondary delivery vehicles. Block 230 may also include block 250 where the delivery vehicle location is monitored on the primary delivery route. Block 230 may also include block 260 where the transient individual location is monitored. Finally, block 230 may also include block 270 where the transient individual location is compared with the delivery vehicle location. Prior to generating the detour route 240, the process may inquiry as to if additional verification 275 is desired. If it is desired, the system may also include block 280 where an individual associated with the transient individual location is messaged to confirm their location prior to generating the detour route. The mobile device 134 may be utilized to communication with the individual via voice calls, text messaging, Internet access, etc. Finally, after generating the detour route 240, the system may inquiry as to bidding 290 for a secondary vehicle delivery. If the bidding is desired, the system 200 may access a bidding process 300 as described in greater detail below.

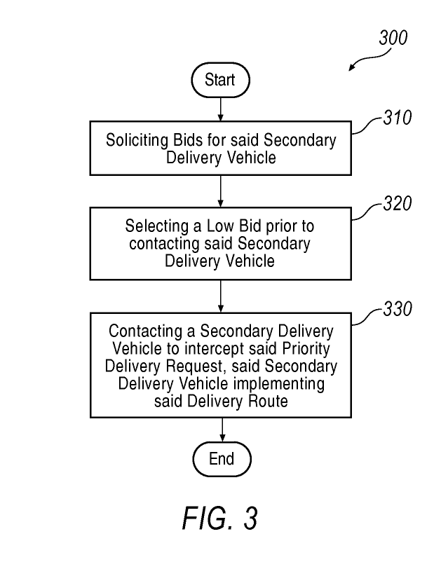

FIG. 3 illustrates an exemplary process flow 300 for handling the detour route of process 200. In block 310 bids are solicited for a secondary delivery vehicle. The bid solicitation may include information relative to the potential detour routes 140, such as from an online location schedule 136, in order for third parties to determine bid quotes. In block 320 a low bid is selected prior to contacting the secondary delivery vehicle. In block 330 a secondary delivery vehicle is contacted to intercept the priority delivery request and implement the detour route. This may allow the primary delivery vehicle to continue on the primary delivery route unencumbered. Additionally, secondary delivery vehicles may already be in route towards the priority delivery location and therefore can bid relatively low amounts to facility delivery.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device configured to execute a software application on a processor of the computing device to provide operations comprising:
computing a primary delivery route based on a plurality of primary delivery addresses;
receiving at least one priority delivery request associated with a transient individual location;
comparing said transient individual location with said primary delivery route;
generating a detour route from said primary delivery route when said transient individual location is proximate to said primary delivery route.

2. A computing device as described in claim 1, further including operations comprising:
monitoring a delivery vehicle location on said primary delivery route;
determining said transient individual location; and
comparing said transient individual location with said delivery vehicle location;
wherein said detour route is generated when said transient individual location is proximate to said delivery vehicle location.

3. A computing device as described in claim 1, further including operations comprising:
communicating with an individual associated with said transient individual location to confirm said transient individual location prior to generating said detour route.

4. A computing device as described in claim 1, wherein said transient individual location is determined by monitoring a mobile device associated with said transient individual location.

5. A computing device as described in claim 1, wherein said transient individual location is determined by referencing a location schedule.

6. A computing device as described in claim 1, further including operations comprising:
contacting a secondary delivery vehicle to intercept said priority delivery request, said secondary delivery vehicle implementing said detour route.

7. A computing device as described in claim 6, further including operations comprising:
soliciting bids for said secondary delivery vehicle including providing a plurality of potential detour routes with the solicitation;
selecting a low bid prior to contacting said secondary delivery vehicle.

8. A method, comprising:
computing a primary delivery route based on a plurality of primary delivery addresses;
receiving at least one priority delivery request associated with a transient individual location;
comparing said transient individual location with said primary delivery route;
generating a detour route from said primary delivery route when said transient individual location is proximate to said primary delivery route.

9. A method as described in claim 8, further comprising:
monitoring a delivery vehicle location on said primary delivery route;
determining said transient individual location; and
comparing said transient individual location with said delivery vehicle location;
wherein said detour route is generated when said transient individual location is proximate to said delivery vehicle location.

10. A method as described in claim 8, further comprising:
communicating with an individual associated with said transient individual location to confirm said transient individual location prior to generating said detour route.

11. A method as described in claim 8, further comprising:
modifying said primary delivery route to include said detour route.

12. A method as described in claim 8, further comprising:
locating a mobile device to determine said transient individual location.

13. A method as described in claim 8, further comprising:
contacting a secondary delivery vehicle to intercept said priority delivery request, said secondary delivery vehicle implementing said detour route.

14. A method as described in claim 13, further comprising:
soliciting bids for said secondary delivery vehicle;
selecting a low bid prior to contacting said secondary delivery vehicle.

15. A system, comprising:
a network configured to determine a transient individual location and monitor a delivery vehicle location;
a computing device configured to:
compute a primary delivery route based on a plurality of primary delivery addresses;
receive at least one priority delivery request associated with said transient individual location;
compare said transient individual location with said primary delivery location; and
generate a detour route from said primary delivery route when said transient individual location is proximate to said primary delivery location.

16. A system as described in claim 15, further comprising:
a bidding system in communication with said computing device, said bidding system configured to:
solicit bids for a secondary delivery vehicle; and
select a secondary delivery vehicle to complete said detour route.

17. A system as described in claim 15, wherein said computing device is further configured to:
schedule a secondary vehicle to meet said delivery vehicle at one of said primary delivery addresses;
wherein said secondary vehicle receives at least one priority package directly from said delivery vehicle.

18. A system as described in claim 15, wherein said computing device is further configured to:
schedule the delivery vehicle to leave at least one priority package at a location along said primary delivery route; and
schedule a secondary vehicle to pick up said at least one priority package and complete said detour route.

19. A system as described in claim 15, wherein said computing device is further configured to:
communicate with an individual associated with said transient individual location to confirm said transient individual location prior to generating said detour route.

20. A system as described in claim 15, further comprising:
a mobile device in communication with said network, said mobile device communicating said transient individual location to said network.
